(19) United States
(12) Patent Application Publication
(10) Pub. No.: US 2011/0074718 A1
(43) Pub. Date: Mar. 31, 2011

(54) FRAME ITEM INSTRUCTION GENERATING METHOD FOR TOUCH PANEL

(75) Inventors: Herng-Ming Yeh, Taoyuan (TW); Yi-Ta Chen, Hsinchu (TW)

(73) Assignee: Higgstec Inc., Taoyuan County (TW)

(21) Appl. No.: 12/891,979

(22) Filed: Sep. 28, 2010

(30) Foreign Application Priority Data
Sep. 30, 2009 (TW) 098133134

(51) Int. Cl. G06F 3/041

(52) U.S. Cl. 345/173

(57) ABSTRACT

A frame item instruction generating method for a touch panel is provided. Firstly, a touch motion of making a click or multiple consecutive clicks on the touch panel and then staying for a while serves as a starting point of entering a frame item mode. Then, a frame item generated by hop-clicking a screen is used to determine an output of a frame item instruction, so as to accurately output the frame item instruction and determine different frame items according to different numbers of the click or consecutive clicks of a user, thereby achieving a function of generating multiple frame items.

### CROSS-REFERENCES TO RELATED APPLICATIONS

This non-provisional application claims priority under 35 U.S.C. §119(a) on Patent Application No. 98133134 filed in Taiwan, R.O.C. on Sep. 30, 2009, the entire contents of which are hereby incorporated by reference.

### BACKGROUND

1. Technical Field

The disclosure relates to a touch panel, and more particularly to a frame item instruction generating method for a touch panel.

2. Related Art

In 2007, Apple Company produced a capacitive touch phone iPhone, and made a record of selling one million sets within 74 days in the mobile phone market. This record was broken by Apple Company's iPhone 3GS in 2009, which set up a record of selling one million sets in three days. These figures demonstrate that touch panel technology has already achieved market success.

The capacitive touch panel applied in the iPhone is a projective capacitive touch panel (PCT), which has an electrode structure formed by multiple X-axis electrodes on a single layer and multiple Y-axis electrodes on a single layer arranged alternately, and detects the touch of an object through X-axis and Y-axis scanning. The technical requirement of multipoint touch gestures is thereby achieved, and the multipoint touch may execute many actions which are impossible by means of single-point touch panels.

The aforementioned multipoint touch function is much preferred by consumers. However, the surface capacitive touch (SCT) panel, the technology of which is relatively mature, can only provide a single-point touch function. SCT panel is therefore inapplicable to products using multipoint touch. Furthermore, the cost structure of SCT panel is lower than that of PCT panel due to the architecture and fabrication process, so that SCT panel will become highly competitive if it can provide a multipoint touch detection function.

FIG. 1 is the basic structure of SCT panel. Electrodes N1, N2, N3, N4 on four corners of a touch panel 1 provide different voltages, so as to form electric fields distributed uniformly on a surface of the panel. In a static state, the electric fields generated by the voltages provided for serially-connected electrodes 12, 14, 16, 18 are distributed uniformly, in which the electric fields distributed uniformly along the X-axis and the Y-axis are formed sequentially, and a stable static capacitor is formed by an upper electrode layer and a lower electrode layer (not shown). As the electrode layer is designed with high impedance, the power consumption of which is rather low. When an object touches a touch coordinate P0 on the touch panel to cause a capacity effect, the touch panel generates a current. The electric fields generated by the supply voltages and distributed uniformly along the X-axis and the Y-axis, the magnitude of the current generated at the four corners is compared by using a connector 20, so as to calculate values of the touch coordinate P0 on the X-axis and Y-axis. So far, the SCT still regards a multipoint touch as a single-point touch in the prior art.

Moreover, in the multipoint touch applications, a single gesture instruction is finally issued regardless of the point number of the multipoint touch. Therefore, if a single-point touch is used to generate a proper touch instruction, the SCT panel generally applied for single-point touch can be employed to obtain more operating functions for a user. In addition to the SCT panel, the resistive touch panel also faces the same problem. Therefore, many touch panel manufacturers face a need to solve the problem of how to enable resistive touch panels and capacitive touch panels to achieve more operating functions with a single-point touch.

### SUMMARY

In order to solve the above problem in the prior art, the disclosure is directed to a frame item instruction generating method for a touch panel. The method includes: detecting a first click of a first object at a first touch coordinate; when the first object stays at the first touch coordinate for a time period that exceeds a period of dwell time after making the first click, entering a frame item mode; in the frame item mode, displaying a plurality of frame items on a periphery of the first touch coordinate according to a plurality of default directions and distances; detecting a second click of a second object at a second touch coordinate, in which the first click and the second click are hop-clicks, and the second touch coordinate is in an item displaying range of one of the frame items; and outputting a frame item instruction according to the frame item corresponding to the second coordinate.

The disclosure is also directed to a frame item instruction generating method for a touch panel, which includes: detecting a first click of a first object at a first touch coordinate; when the first object stays at the first touch coordinate for exceeding a period of dwell time after making the first click, entering a frame item mode; in the frame item mode, displaying a plurality of frame items on a periphery of the first touch coordinate through a plurality of default directions and distances according to a number of the first click; detecting a second click of a second object at a second touch coordinate, in which the first click and the second click are hop-clicks, and the second touch coordinate is in an item displaying range of one of the frame items; and outputting a frame item instruction according to the frame item corresponding to the second coordinate.

The detailed features and advantages of the disclosure will be described in detail in the following embodiments. Those skilled in the art can easily understand and implement the content of the disclosure. Furthermore, the relative objectives and advantages of the disclosure are apparent to those skilled in the art with reference to the content disclosed in the specification, claims, and drawings.

### BRIEF DESCRIPTION OF THE DRAWINGS

The disclosure will become more fully understood from the detailed description given herein below for illustration only, and thus are not limitative of the disclosure, and wherein:

FIG. 1 is a schematic view of touch detection of a capacitive touch panel in the prior art;

FIGS. 2A to 2G are schematic views of a frame item instruction generating method for a touch panel according to the disclosure;

FIG. 3 is a first flow chart of the frame item instruction generating method for a touch panel according to the disclosure;

FIG. 4 is a second flow chart of the frame item instruction generating method for a touch panel according to the disclosure; and

FIG. 5 is a third flow chart of the frame item instruction generating method for a touch panel according to the disclosure.

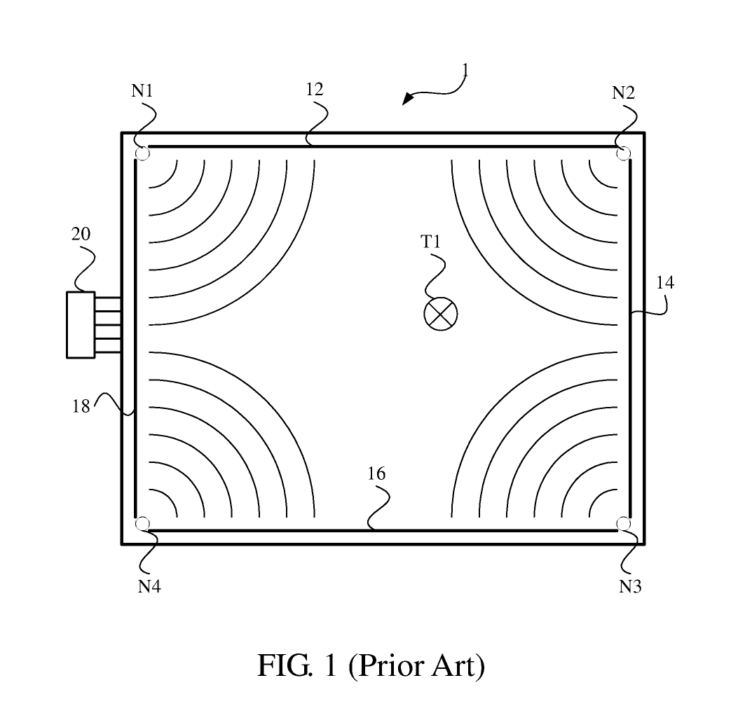

### DETAILED DESCRIPTION

The disclosure is mainly characterized by the fact that a frame item mode of a touch panel is generated by clicking the touch panel with a finger and then staying at the touch point for a period of dwell time. That is, when a user intends to enter the frame item mode, a frame item is generated by making a click or multiple consecutive clicks on the touch panel and then staying for a period of dwell time. Afterward, the user clicks a pattern on a frame, so as to enable the touch panel to output a corresponding item instruction to an information processing device.

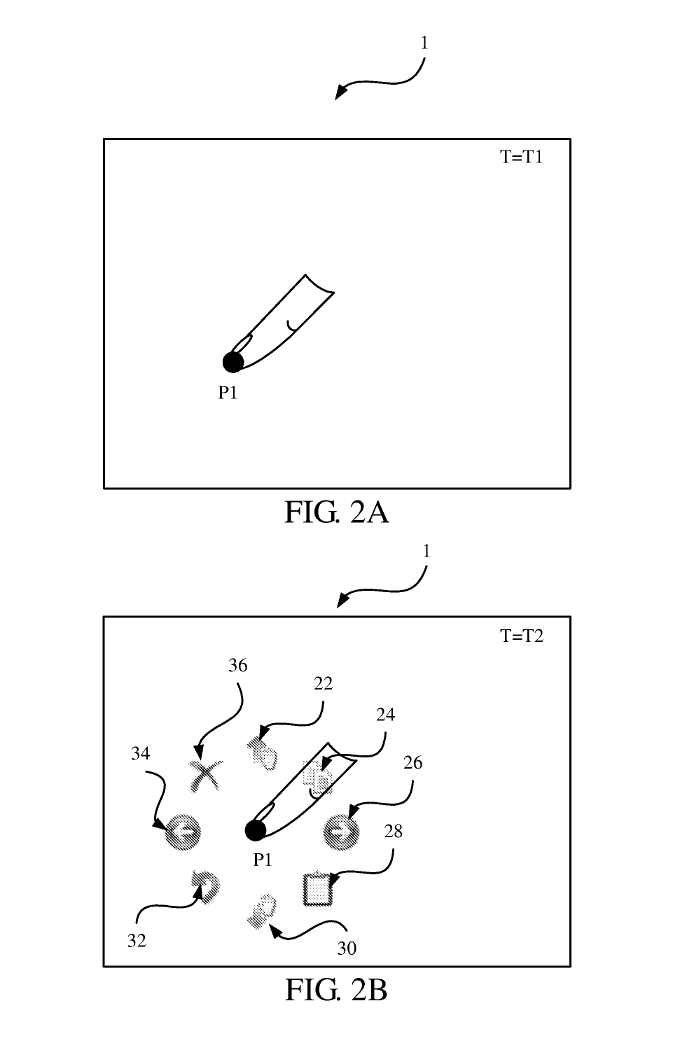

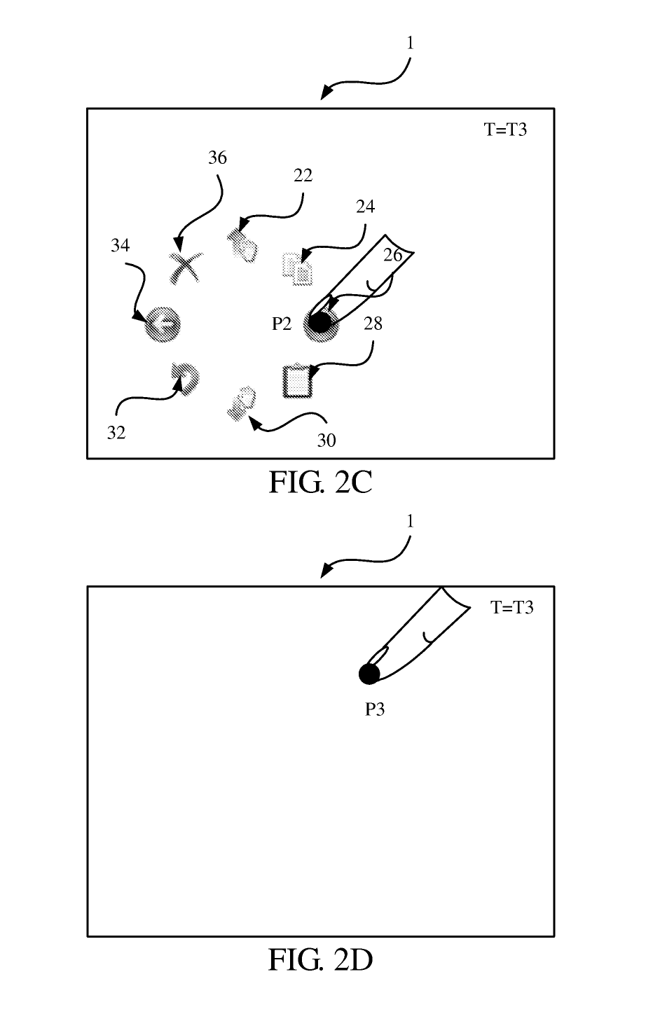

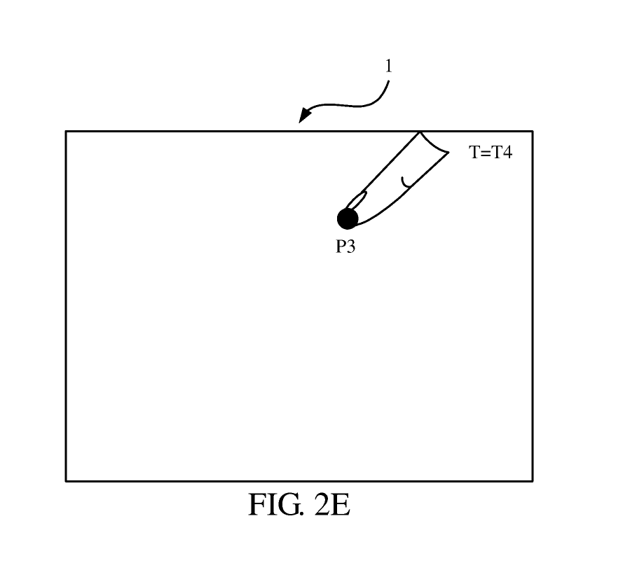

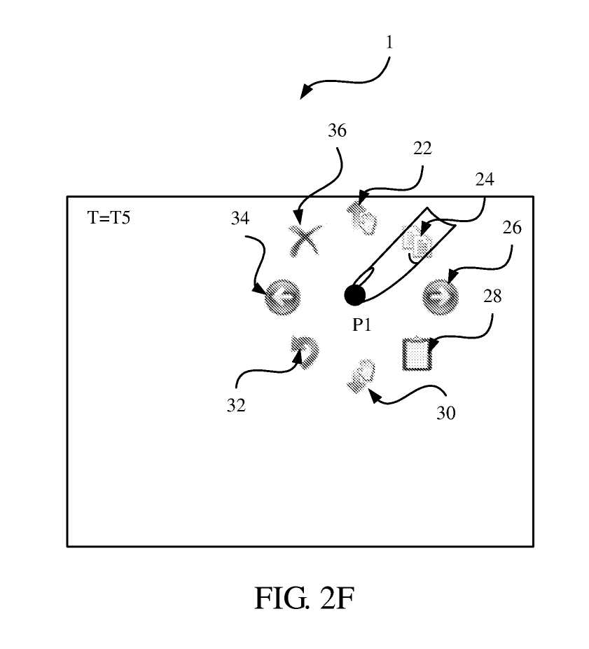

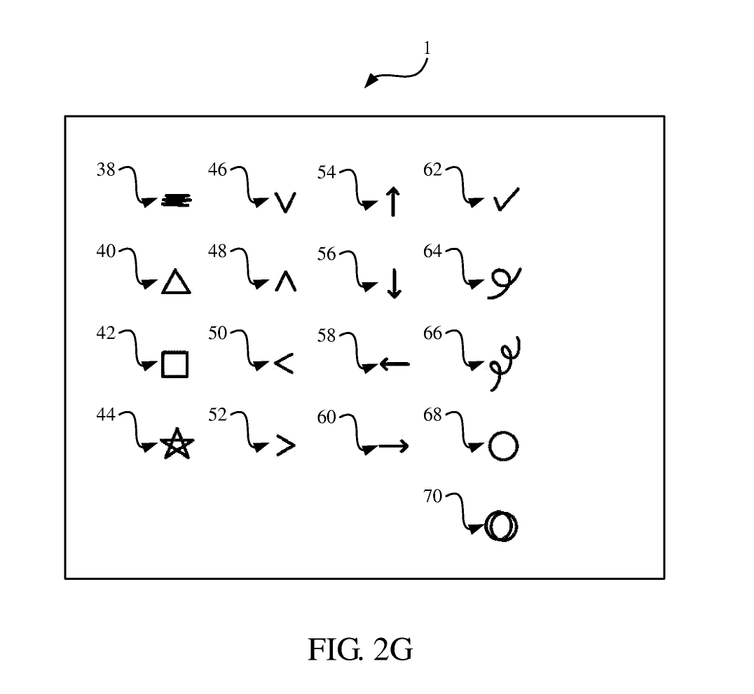

FIGS. 2A to 2F are schematic views of the implementation of a frame item instruction generating method for a touch panel according to the disclosure. Firstly, referring to FIG. 2A, a finger touches a touch coordinate P1 on the touch panel 1 when T=T1. After the finger stays at the touch coordinate P1 for a period of dwell time, a frame is presented at T=T2. The frame item as shown in FIG. 2B is uniformly arranged at equal intervals in a circle on the periphery of the touch coordinate P1 with the touch coordinate P1 as a center of the circle, that is, in eight different directions, including: a drag up item 22, a copy item 24, a forward item 26, a paste item 28, a drag down item 30, an undo item 32, a back item 34, and a delete item 36. The eight items are provided for the user to choose which action from the frame item. Of course, the user has the ability to decide whether or not to use the frame item.

Next, referring to FIG. 2C, the user clicks the pattern of the forward item 26 when T=T3, that is, clicks at a touch coordinate P2 in the item displaying range of the forward item 26, and thus, the system generates an instruction corresponding to the forward item 26.

If the user clicks a touch coordinate P3 instead of any coordinate of the frame item at T=T3, the frame item mode quitted, that is, the patterns of the frame items originally displayed in FIG. 2B all disappear, as shown in FIG. 2D. If the user continuously touches the touch coordinate P3 for exceeding a period of default dwell time, as shown in FIG. 2E, the finger still stays at a touch coordinate P4 when T=T4, the same patterns of the frame items are generated on the periphery of the touch coordinate P3 on the screen, as shown in FIG. 2F.

In the disclosure, the following two methods are used to enter the frame item mode: implementing a single-click and dwelling for a time; and implementing a double-click or other multiple consecutive clicks like three consecutive clicks or four consecutive clicks, and dwelling for a time, in which the multiple consecutive clicks are touched at the same point, and the definition of the same point may be expanded to points nearby. The second method actually represents various types of consecutive clicks. The disclosure may define the selection of different frame items according to different numbers of consecutive clicks.

For example, FIGS. 2A to 2F are the patterns of the frame items in eight directions on the periphery of the touch coordinate P1 or the touch coordinate P3, including: the drag up item 22, the copy item 24, the forward item 26, the paste item 28, the drag down item 30, the undo item 32, the back item 34, and the delete item 36.

According to the disclosure, in addition to the appearance of the eight frame items through a single-click, the user may double-click the touch coordinate and stay for a period of dwell time to generate another item frame (the two item frames may exchange with each other), for example, four frame items, including: clockwise rotation; counterclockwise rotation; zoom in; and zoom out. Alternatively, the user may implement three consecutive clicks and stay for a period of dwell time to generate four frame items, including: check-off; insert; erase content; and cut.

Other items may be selected from a group consisting of: application specific, move cursor left, move cursor right, decrease indent, space, enter, tab, input method editor (IME) convert, and backspace items.

For example, the symbols in FIG. 2G may be used as the item symbols, including: an erase content item 38, an action item 42, an action item 44, an insert item 46, a paste and insert item 48, an application specific item 50, an application specific item 52, an application specific item 54, an application specific item 56, an application specific item 58, an application specific item 60, a check-off item 62, a cut item 64, a copy item 66, an application specific item 68, and a paste item 70.

In addition to the circular arrangement in FIGS. 2A to 2F, the frame items may be arranged in other manners, for example, arranged in parallel in a whole row or arranged in a row above the touch point, below the touch point, on the left of the touch point, or on the right of the touch point, or arranged in two columns in parallel on the left and right of the touch point, or arranged in two rows in parallel above and below the touch point, or arranged in a diagonal, and so on. That is to say, the frame items may be arranged in different manners depending on the actual requirements of the users.

In this way, the different frame items may be generated by using the same determination method according to different numbers of the click made by the user.

The process of the disclosure is described below in a flow chart.

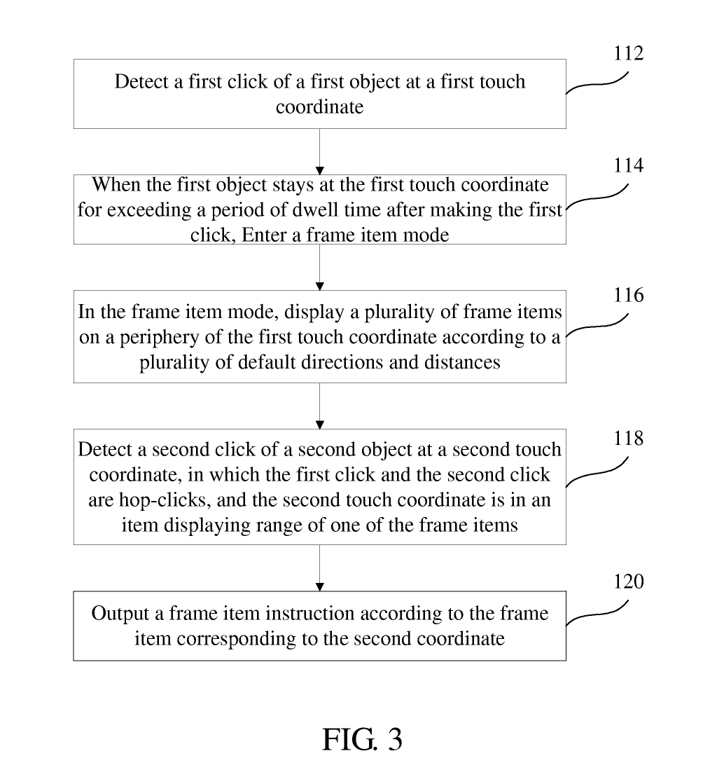

FIG. 3 is a first flow chart of the frame item instruction generating method for a touch panel according to the disclosure, which includes the following steps.

In Step 112, a first click of a first object at a first touch coordinate is detected. Meanwhile, the first touch coordinate may be output.

In Step 114, when the first object stays at the first touch coordinate for exceeding a period of dwell time after making the first click, a frame item mode is entered. The period of dwell time is in a range of 0.1 s to 3 s.

In Step 116, in the frame item mode, a plurality of frame items is displayed on a periphery of the first touch coordinate according to a plurality of default directions and distances. For example, different frame items are displayed at an interval of a width of a finger in a manner of dividing a circle into two, three, four, five, six, seven, eight, or other equal parts. As the embodiment in FIGS. 2A to 2F, the frame items are arranged by dividing a circle into eight equal parts, that the first touch coordinate of the first object is as a center of the circle. Each frame item is corresponding to a pattern, a symbol, or a character for identification. Other arrangements are also applicable, which may be deduced in the same manner.

In Step 118, a second click of a second object at a second touch coordinate is detected, in which the first click and the second click are hop-clicks, and the second touch coordinate is lied in an item displaying range of one of the frame items. As the frame item is spaced from the first touch coordinate by a distance of a width of a finger, false touch may be avoided by determining the frame item through hop-click. As the item displaying range of each frame item is determined after entering the frame item mode, and the item displaying ranges are specified, it is unlikely for the user to touch the specified item displaying ranges by mistake. Moreover, if the hop-click is used for determination, the probability of a false touch is even lower. Therefore, the above mechanism employed for determining the frame item may greatly reduce the probability of false touch, so as to enable the user to select accurately the frame item of the disclosure without worrying about a false touch.

In Step 120, a frame item instruction is output according to the frame item corresponding to the second coordinate.

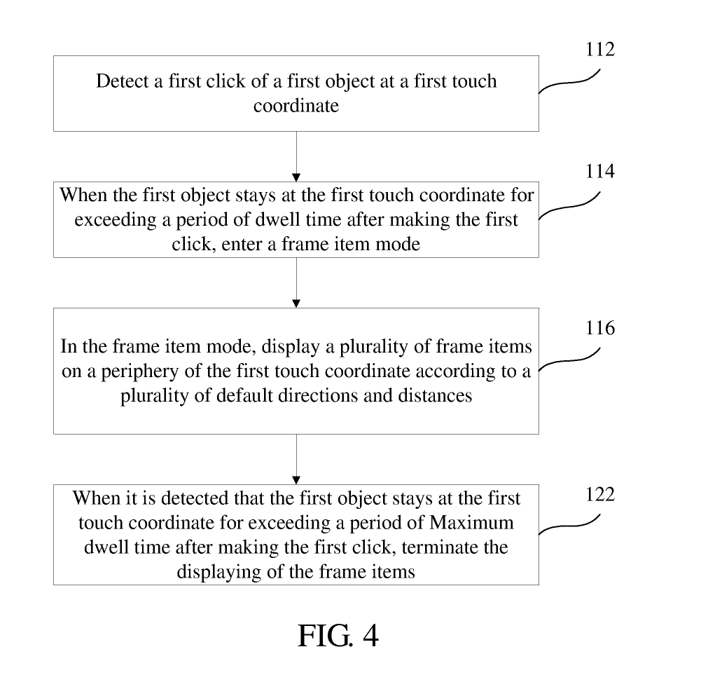

FIG. 4 is a second flow chart of the frame item instruction generating method for a touch panel according to the disclosure, which includes the following steps.

In Step 112, a first click of a first object at a first touch coordinate is detected. Meanwhile, the first touch coordinate may be output.

In Step 114, when the first object stays at the first touch coordinate for exceeding a period of dwell time after making the first click, a frame item mode is entered. The period of dwell time is in a range of 0.1 s to 3 s.

In Step 116, in the frame item mode, a plurality of frame items is displayed on a periphery of the first touch coordinate according to a plurality of default directions and distances.

In addition to the circular arrangement in FIGS. 2A to 2F, the frame items may also be arranged in one line or in two or three lines or the like, including, for example, left and right columns as well as upper and lower rows.

In Step 122, when it is detected that the first object stays at the first touch coordinate for exceeding a period of maximum dwell time after making the first click, the displaying of the frame items is terminated. The period of maximum dwell time is in a range of 3 s to 5 s.

Here, Steps 112, 114, and 116 are similar to those in FIG. 3, and FIG. 4 mainly is the operations when the user does not click any frame item. If the user fails to click a frame item within the period of maximum dwell time, the system determines that the user does not intend to click, or is still in consideration. In this case, the user may enter the frame item mode once again.

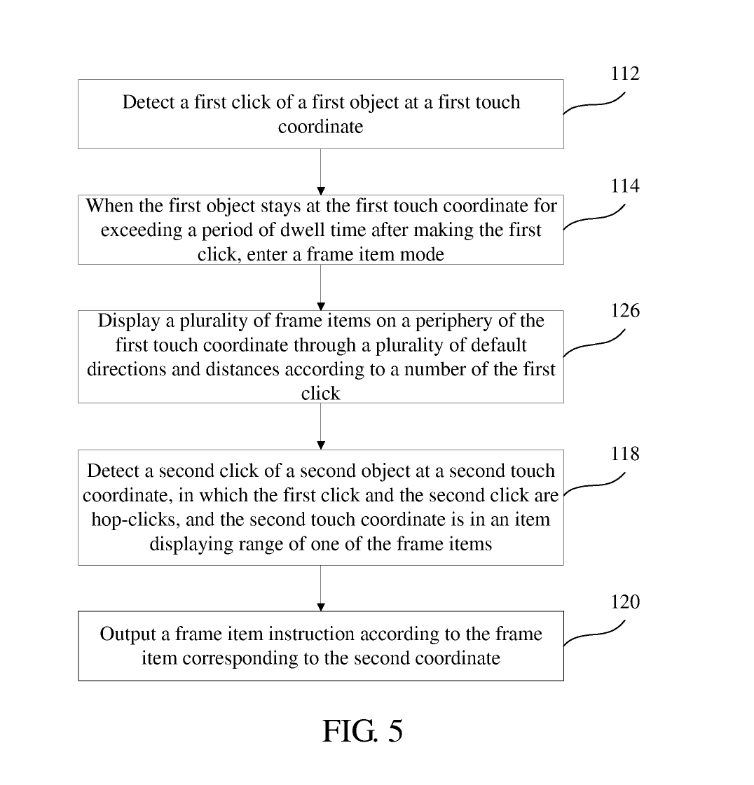

FIG. 5 is a third flow chart of the frame item instruction generating method for a touch panel according to the disclosure, which includes the following steps.

In Step 112, a first click of a first object at a first touch coordinate is detected. Meanwhile, the first touch coordinate may be output.

In Step 114, when the first object stays at the first touch coordinate for exceeding a period of dwell time after making the first click, a frame item mode is entered. The period of dwell time is in a range of 0.1 s to 3 s.

In Step 126, a plurality of frame items is displayed on a periphery of the first touch coordinate through a plurality of default directions and distances according to a number of the first click. That is, if a single-click is performed in Step 124, a group of frame items is adopted; if a double-click is performed in Step 124, another group of frame items is adopted; and if three consecutive clicks are performed in Step 124, still another group of frame items is adopted. The rest can be deduced in the same manner.

In Step 118, a second click of a second object at a second touch coordinate is detected, in which the first click and the second click are hop-clicks, and the second touch coordinate is in an item displaying range of one of the frame items.

In Step 120, a frame item instruction is output according to the frame item corresponding to the second coordinate.

The difference between the processes in FIG. 5 and FIG. 3 are in Step 116 and Step 126. The first click in the embodiment of FIG. 3 refers to a single click of the first object, while the first click in the embodiment of FIG. 5 refers to consecutive clicks of the first object, and the appearance of the frame items is determined by the number of the consecutive clicks in FIG. 5.

The determination of the circumstance that exceeds the period of maximum dwell time may compensate the operations when the user does not click any frame item. If the user hop-clicks other coordinates different from those of the frame items in the frame item mode, the frame item mode is also quitted. That is to say, when the touch panel detects the click of the second object at the second touch coordinate and the second touch coordinate is not the coordinate of one of the frame items, the frame item mode is quitted.

In another circumstance, the frame item mode is quitted when it is detected that the first object moves in the frame item mode.

While the disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A frame item instruction generating method for a touch panel, comprising the steps of:
detecting a first click of a first object at a first touch coordinate;
entering a frame item mode when the first object stays at the first touch coordinate for exceeding a period of dwell time after making the first click;
in the frame item mode, displaying a plurality of frame items on a periphery of the first touch coordinate according to a plurality of default directions and distances;
detecting a second click of a second object at a second touch coordinate, wherein the first click and the second click are hop-clicks, and the second touch coordinate is lied in an item displaying range of one of the frame items; and
outputting a frame item instruction according to the frame item corresponding to the second coordinate.

2. The method according to claim 1, further comprising the step of:
quitting the frame item mode when detecting the first object stays at the first touch coordinate for exceeding a period of maximum dwell time after making the first click.

3. The method according to claim 2, wherein the period of maximum dwell time is a range of 3 s to 5 s.

4. The method according to claim 1, wherein the period of dwell time is in a range of 0.1 s to 3 s.

5. The method according to claim 1, further comprising the step of:
in the frame item mode, when detecting the second click of the second object at the second touch coordinate and the second touch coordinate is not lied in the item displaying range of any of the frame items, quitting the frame item mode.

6. The method according to claim 1, further comprising the step of:
in the frame item mode, quitting the frame item mode when detecting the first object moves.

7. The method according to claim 1, wherein the frame items are selected from a group consisting of: drag up, drag down, forward, back, delete, undo, copy, paste, clockwise rotation, counterclockwise rotation, zoom in, zoom out, check-off, insert, erase content, cut, application specific, move cursor left, move cursor right, decrease indent, space, enter, tab, input method editor (IME) convert, backspace, action, and paste and insert items.

8. The method according to claim 1, wherein the frame items are respectively corresponding to a pattern, a symbol, a character, or any combination thereof.

9. The method according to claim 1, further comprising the steps of:
outputting a coordinate of the first object; and
outputting a frame item mode instruction.

10. The method according to claim 1, wherein the default directions and distances are selected from a group consisting of uniformly arranging the frame items at an interval of the distance in a circle with the first touch coordinate as a center of the circle; arranging the frame items in at least one whole line at an interval of the distance of the first touch coordinate; arranging the frame items in at least one column at an interval of the distance of the first touch coordinate; arranging the frame items in at least one row at an interval of the distance of the first touch coordinate; or arranging the frame items in columns and rows at an interval of the distance of the first touch coordinate.

11. A frame item instruction generating method for a touch panel, comprising the steps of:
detecting a first click of a first object at a first touch coordinate;
entering a frame item mode when the first object stays at the first touch coordinate for exceeding a period of dwell time after making the first click;
in the frame item mode, displaying a plurality of frame items on a periphery of the first touch coordinate through a plurality of default directions and distances according to a number of the first click;
detecting a second click of a second object at a second touch coordinate, wherein the first click and the second click are hop-clicks, and the second touch coordinate is lied in an item displaying range of one of the frame items; and
outputting a frame item instruction according to the frame item corresponding to the second coordinate.

12. The method according to claim 11, further comprising the step of:
quitting the frame item mode when it is detected that the first object stays at the first touch coordinate for exceeding a period of maximum dwell time after making the first click.

13. The method according to claim 12, wherein the period of maximum dwell time is in a range of 3 s to 5 s.

14. The method according to claim 11, wherein the period of dwell time is in a range of 0.1 s to 3 s.

15. The method according to claim 11, further comprising the step of:
in the frame item mode, quitting the frame item mode when detecting the second click of the second object at the second touch coordinate and the second touch coordinate is not in the item displaying range of any of the frame items.

16. The method according to claim 11, further comprising the step of:
in the frame item mode, quitting the frame item mode when detecting the first object moves.

17. The method according to claim 11, wherein the frame items are selected from a group consisting of: drag up, drag down, forward, back, delete, undo, copy, paste, clockwise rotation, counterclockwise rotation, zoom in, zoom out, check-off, insert, erase content, cut, application specific, move cursor left, move cursor right, decrease indent, space, enter, tab, input method editor (IME) convert, backspace, action, and paste and insert items.

18. The method according to claim 11, wherein the frame items are respectively corresponding to a pattern, a symbol, a character, or any combination thereof.

19. The method according to claim 11, further comprising the steps of:
outputting a coordinate of the first object; and
outputting a frame item mode instruction.

20. The method according to claim 11, wherein the default directions and distances are selected from a group consisting of: uniformly arranging the frame items at an interval of the distance in a circle with the first touch coordinate as a center of the circle; arranging the frame items in at least one whole line at an interval of the distance of the first touch coordinate; arranging the frame items in at least one column at an interval of the distance of the first touch coordinate; arranging the frame items in at least one row at an interval of the distance of the first touch coordinate; or arranging the frame items in columns and rows at an interval of the distance of the first touch coordinate.
